(19) United States
(12) Patent Application Publication
(10) Pub. No.: US 2026/0032676 A1
(43) Pub. Date: Jan. 29, 2026

(54) HD-FDD RX-TX SWITCHING CAPABILITY

(71) Applicant: QUALCOMM Incorporated, San Diego, CA (US)

(72) Inventors: Peer BERGER, Hod Hasharon (IL); Shay LANDIS, Hod Hasharon (IL); Jacob PICK, Mevaseret Zion (IL); Assaf TOUBOUL, Netanya (IL)

(21) Appl. No.: 18/784,820

(22) Filed: Jul. 25, 2024

(51) Int. Cl. H04W 72/1268; H04L 5/16

(52) U.S. Cl. CPC H04W 72/1268; H04L 5/16

(57) ABSTRACT

The apparatus configured to transmit, to a network device, a first indication of a minimum time associated with switching between a first frequency used for DL communication and a second frequency used for UL communication, receive, from the network device via the first frequency, a second indication scheduling an UL communication at a time that is no sooner than the minimum time after the second indication is received, switch from the first frequency to the second frequency based on the second indication, and transmit the scheduled UL communication via the second frequency.

### TECHNICAL FIELD

The present disclosure relates generally to communication systems, and more particularly, to a half-duplex (HD) frequency division duplexing (FDD) (HD-FDD) mode of wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a wireless device such as a user equipment (UE) or a component thereof configured to transmit, to a network device, a first indication of a minimum time associated with switching between a first frequency used for downlink (DL) communication and a second frequency used for uplink (UL) communication, receive, from the network device via the first frequency, a second indication scheduling an UL communication at a time that is no sooner than the minimum time after the second indication is received, switch from the first frequency to the second frequency based on the second indication, and transmit the scheduled UL communication via the second frequency.

In an aspect of the disclosure, a method, a computer-readable medium, and an apparatus are provided. The apparatus may be a network device, network node, or network entity, such as a base station or a component thereof configured to receive, from a first UE, a first indication of a minimum time associated with the first UE switching from a first frequency used for DL communication to a second frequency used for UL communication, transmit, via the first frequency, a second indication scheduling an UL communication from the first UE at a time that is no sooner than the minimum time after the second indication is expected to be decoded, and refrain from transmitting a DL communication via the first frequency within the minimum time before a beginning of the scheduled UL communication.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and UE in an access network.

FIG. 4 is a diagram illustrating aspects of HD-FDD communication in accordance with some aspects of the disclosure.

FIG. 5 is a set of diagrams illustrating HD-FDD communication between a base station with two UEs with different capabilities in accordance with some aspects of the disclosure.

FIG. 6A is a diagram illustrating possible slot structures for sub-slot switching times in accordance with some aspects of the disclosure.

FIG. 6B illustrates examples of a slot with a mixture of uplink and downlink resources, in accordance with some aspects of the disclosure.

FIG. 7 is a communication flow diagram illustrating a method of wireless communication in accordance with some aspects of the disclosure.

FIG. 8 is a flowchart of a method of wireless communication.

FIG. 9 is a flowchart of a method of wireless communication.

FIG. 10 is a flowchart of a method of wireless communication.

FIG. 11 is a diagram illustrating an example of a hardware implementation for an example apparatus and/or network entity.

FIG. 12 is a diagram illustrating an example of a hardware implementation for an example network entity.

FIG. 13 is a diagram illustrating an example of a hardware implementation for an example network entity.

### DETAILED DESCRIPTION

In some aspects of wireless communication, a HD-FDD mode of communication may be used in which transmission and reception use two different frequencies in two different slots. In some aspects, Non-Terrestrial Networks (NTNs) including satellites orbiting Earth may act as communication relays, providing coverage even in remote or challenging terrains where terrestrial towers are absent. NTNs may eliminate dead spots, providing constant connectivity regardless of location. In some aspects, NTNs may use a high frequency range (e.g., FR2 (24.25 GHz-52.6 GHz)) to increase a throughput using a large bandwidth available in the high frequency range. Due to long round trip time, there may be a preference to use FDD at a network device of the NTN (e.g., a satellite) while HD may be used due to isolation issues in a duplexer of a UE. Accordingly, NTN communication in FR2 may use HD-FDD and the difference between the frequencies may be very large (e.g., a difference of ˜10 GHz may be used when transmitting DL using a carrier frequency around 20 GHz and transmitting UL using a carrier around 30 GHz).

The convergence time of a Phase-Locked Loop (PLL) when switching the carrier frequency may be influenced by the absolute difference between the old and new frequencies. In some aspects, a convergence time may be increased for larger frequency differences because a voltage-controlled oscillator (VCO) frequency may be adjusted to lock onto the new carrier frequency and a larger frequency step may be associated with a longer time to lock. Assuming there is a joint PLL for both transmission and reception, the UE's switching and/or transition time may depend on the difference between the two frequencies and, when the difference between the two frequencies is large (e.g., greater than 2.5 GHz, 5 GHz, 10 GHz, or more), may not allow switching between transmission and reception on consecutive slots.

Various aspects relate generally to a UE capability for indicating to a base station how much time it takes for the UE to switch between transmission and reception (or vice versa) in association with FR2 (NTN) HD-FDD operation. In some examples, a wireless device may be configured to transmit, to a network device, a first indication of a minimum time associated with switching between a first frequency used for DL communication and a second frequency used for UL communication, receive, from the network device via the first frequency, a second indication scheduling an UL communication at a time that is no sooner than the minimum time after the second indication is received, switch from the first frequency to the second frequency based on the second indication, and transmit the scheduled UL communication via the second frequency. In some examples, a base station may be configured to receive, from a first UE, a first indication of a minimum time associated with the first UE switching from a first frequency used for DL communication to a second frequency used for UL communication, transmit, via the first frequency, a second indication scheduling an UL communication from the first UE at a time that is no sooner than the minimum time after the second indication is expected to be decoded, and refrain from transmitting a DL communication via the first frequency within the minimum time before a beginning of the scheduled UL communication.

Particular aspects of the subject matter described in this disclosure can be implemented to realize one or more of the following potential advantages. In some examples, by having a UE indicate a switching and/or transition time to a base station, the described techniques can be used to appropriately schedule UL and/or DL transmission despite different UEs having different capabilities for switching between frequencies and avoid introducing an overly long time between a DL transmission and a subsequent UL transmission (or vice versa) that accommodates a worst case, or average, switching and/or transition time.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

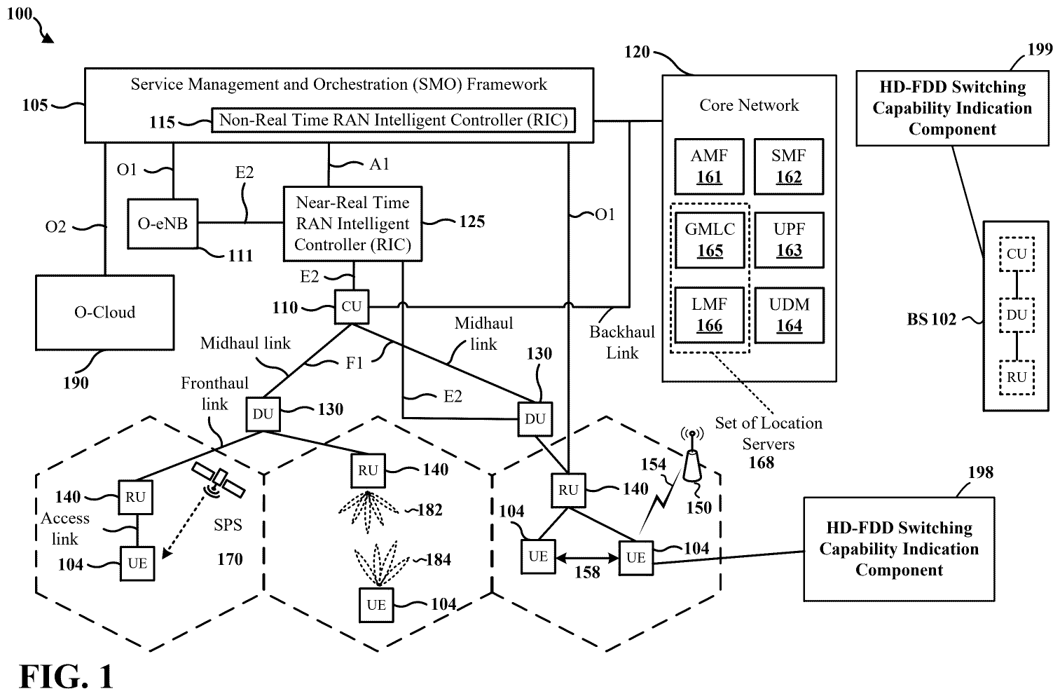

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit—User Plane (CU-UP)), control plane functionality (i.e., Central Unit—Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a HD-FDD switching capability indication component 198 that may be configured to transmit, to a network device, a first indication of a minimum time associated with switching between a first frequency used for DL communication and a second frequency used for UL communication, receive, from the network device via the first frequency, a second indication scheduling an UL communication at a time that is no sooner than the minimum time after the second indication is received, switch from the first frequency to the second frequency based on the second indication, and transmit the scheduled UL communication via the second frequency. In certain aspects, the base station 102 may have a HD-FDD switching capability indication component 199 that may be configured to receive, from a first UE, a first indication of a minimum time associated with the first UE switching from a first frequency used for DL communication to a second frequency used for UL communication, transmit, via the first frequency, a second indication scheduling an UL communication from the first UE at a time that is no sooner than the minimum time after the second indication is expected to be decoded, and refrain from transmitting a DL communication via the first frequency within the minimum time before a beginning of the scheduled UL communication. Although the following description may be focused on NTNs and NR, the concepts described herein may be applicable to other similar areas, such as terrestrial networks and LTE, LTE-A, CDMA, GSM, and other wireless technologies using HD-FDD.

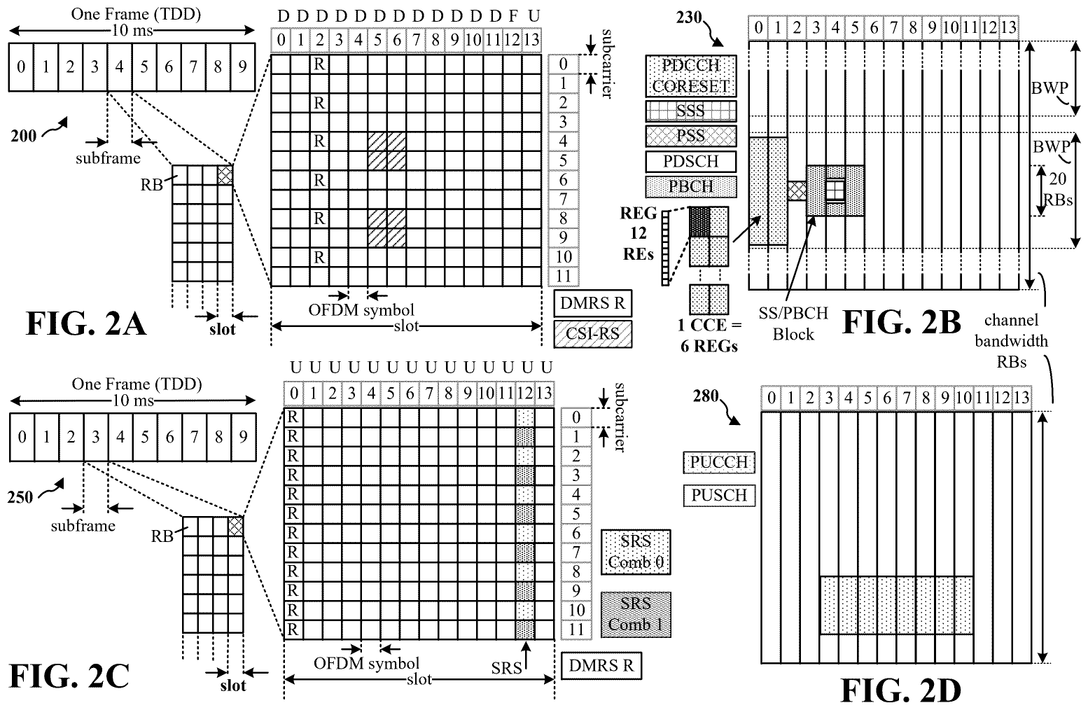

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

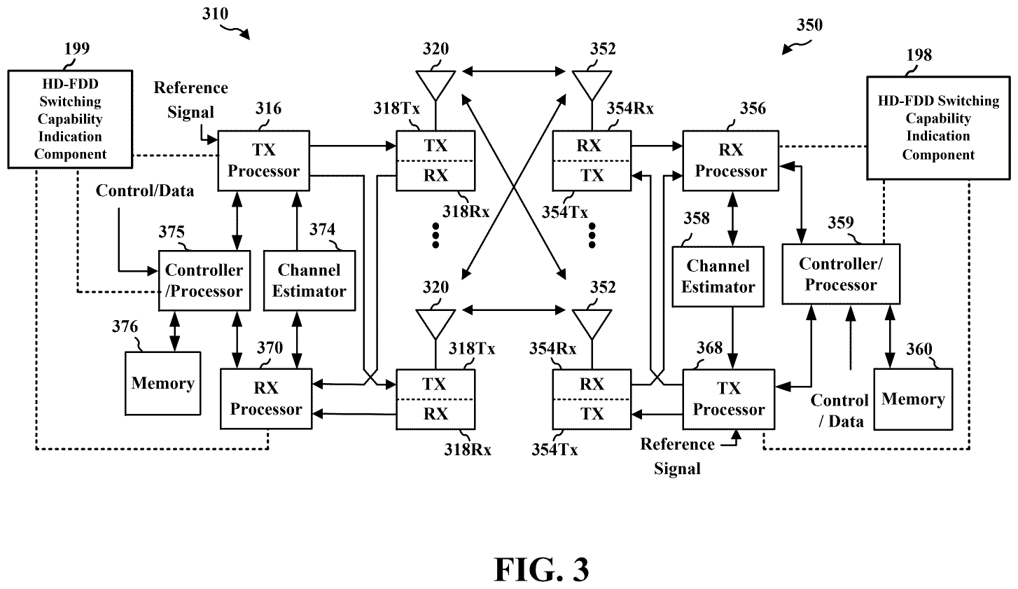

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antennas 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the HD-FDD switching capability indication component 198 of FIG. 1.

At least one of the TX processor 316, the RX processor 370, and the controller/processor 375 may be configured to perform aspects in connection with the HD-FDD switching capability indication component 199 of FIG. 1.

In some aspects of wireless communication, a HD-FDD mode of communication may be used in which transmission and reception use two different frequencies in two different slots. In some aspects, NTNs including satellites orbiting Earth may act as communication relays, providing coverage even in remote or challenging terrains where terrestrial towers are absent. NTNs may eliminate dead spots, providing constant connectivity regardless of location. In some aspects, NTNs may use a high frequency range (e.g., FR2) to increase a throughput using a large bandwidth available in the high frequency range. Due to long round trip time, there may be a preference to use FDD at a network device of the NTN (e.g., a satellite) while HD may be used due to isolation issues in a duplexer of a UE. Accordingly, NTN communication in FR2 may use HD-FDD and the difference between the frequencies may be very large (e.g., a difference of ˜10 GHz may be used when transmitting DL using a carrier frequency around 20 GHz and transmitting UL using a carrier around 30 GHz).

The convergence time of a PLL when switching the carrier frequency may be influenced by the absolute difference between the old and new frequencies. In some aspects, a convergence time may be increased for larger frequency differences because a VCO frequency may be adjusted to lock onto the new carrier frequency and a larger frequency step may be associated with a longer time to lock. Assuming there is a joint PLL for both transmission and reception, the UE's switching and/or transition time may depend on the difference between the two frequencies and, when the difference between the two frequencies is large (e.g., greater than 2.5 GHz, 5 GHz, 10 GHz, or more), may not allow switching between transmission and reception on consecutive slots.

In some aspects, for a PLL, the VCO generates a frequency that is controlled by a voltage input. The output frequency of the VCO is divided down and then compared to a reference frequency by the phase detector. The phase detector generates an error signal which is filtered and used to adjust the VCO frequency. This feedback mechanism allows the PLL to lock onto the desired frequency. When the carrier frequency is switched, the PLL needs to adjust the VCO frequency to lock onto the new carrier frequency. The speed at which this happens, e.g., a convergence time, in some aspects may be determined by the dynamics of the PLL, particularly the loop bandwidth. A wider loop bandwidth allows for faster locking (shorter convergence time), but it also makes the PLL more susceptible to noise.

In a practical sense, the convergence time of a PLL when switching the carrier frequency may be influenced by the absolute difference between the old and new frequencies. This is because the PLL adjusts the VCO frequency to lock onto the new carrier frequency, and a larger frequency step may be associated with a longer time to lock. For example, switching from 1 GHz to 2 GHz (a difference of 1 GHz) would likely take less time than switching from 10 GHz to 20 GHz (a difference of 10 GHz). In some aspects, the convergence time may also be influenced by other factors such as the loop bandwidth, the phase detector gain, the VCO gain, and the loop filter. The specific design and parameters of the PLL play a role in determining the convergence time and may vary between UEs. Accordingly, when the convergence time (e.g., a switching time between a first frequency and a second frequency) may be a limiting factor in a gap between UL and DL communication, being able to identify a UE-specific convergence time (or switching time) may avoid a UE being scheduled for UL too close to a DL communication or being unable to receive a DL transmission too soon after an UL transmission due to underestimating a switching time or may avoid introducing additional overhead/unused resources around a switch due to overestimating a switching time.

Various aspects relate generally to a UE capability for indicating to a base station how much time it takes for the UE to switch between transmission and reception (or vice versa) in association with FR2 NTN HD-FDD operation. In some examples, a wireless device may be configured to transmit, to a network device, a first indication of a minimum time associated with switching between a first frequency used for DL communication and a second frequency used for UL communication, receive, from the network device via the first frequency, a second indication scheduling an UL communication at a time that is no sooner than the minimum time after the second indication is received, switch from the first frequency to the second frequency based on the second indication, and transmit the scheduled UL communication via the second frequency. In some examples, a base station may be configured to receive, from a first UE, a first indication of a minimum time associated with the first UE switching from a first frequency used for DL communication to a second frequency used for UL communication, transmit, via the first frequency, a second indication scheduling an UL communication from the first UE at a time that is no sooner than the minimum time after the second indication is expected to be decoded, and refrain from transmitting a DL communication via the first frequency within the minimum time before a beginning of the scheduled UL communication.

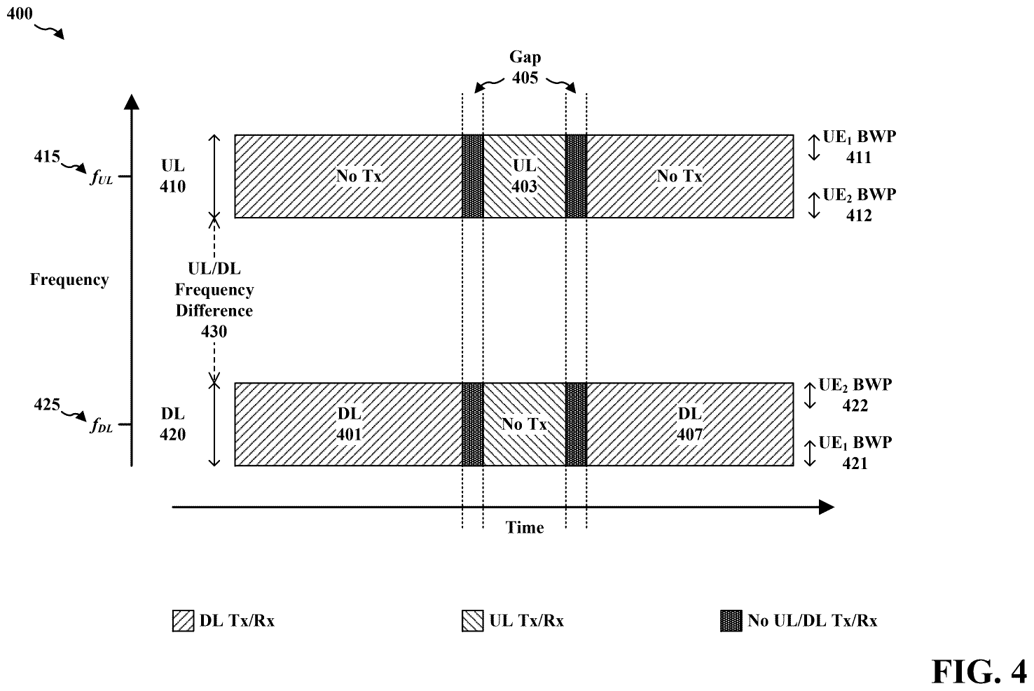

FIG. 4 is a diagram 400 illustrating aspects of HD-FDD communication in accordance with some aspects of the disclosure. In some aspects, FDD (and more specifically, HD-FDD) communication may be associated with a first frequency range 420 or central carrier frequency 425 for DL transmissions and a second frequency range 410 or central carrier frequency 415 for UL transmissions. The first frequency range 420 and the second frequency range 410, in some aspects, may be separated by a frequency difference 430 which may be measured as the difference between a highest frequency of a lower frequency range (e.g., first frequency range 420 in diagram 400) and a lowest frequency of a higher frequency range (e.g., second frequency range 410 in diagram 400) or as a difference between the associated central carrier frequencies (e.g., between central carrier frequency 415 and central carrier frequency 425). Within the first frequency range 420 (or the second frequency range 410) different sub-ranges may be associated with and/or allocated for, or to, different UEs. For example, a first UE (“UE₁”) may be associated with BWP 411 for UL transmissions and a BWP 421 for DL transmissions while a second UE (“UE₂”) may be associated with BWP 412 for UL transmissions and a BWP 422 for DL transmissions.

In addition to using different frequencies (e.g., frequency ranges and/or central carrier frequencies), HD-FDD, in some aspects, also separates UL and DL transmissions in time. For example, for a first UE, a first time period may be associated with a DL transmission 401, a second time period may be associated with an UL transmission 403 and the first and second time periods may be separated by a gap 405 to allow for switching between UL transmission and DL reception at the first UE (or UL reception and DL transmission at the base station). The length and/or duration of the gap 405, in some aspects, may be based on the UE capability which may in turn be based on a PLL convergence time (e.g., a switching time) of a PLL of the first UE or a timing advance associated with the communication link between the first UE and the base station. The gap 405 may also be introduced between the second time period and a third time period associated with a subsequent DL transmission 407 where a gap associated with a switch from DL to UL may be different than a gap when switching from UL to DL.

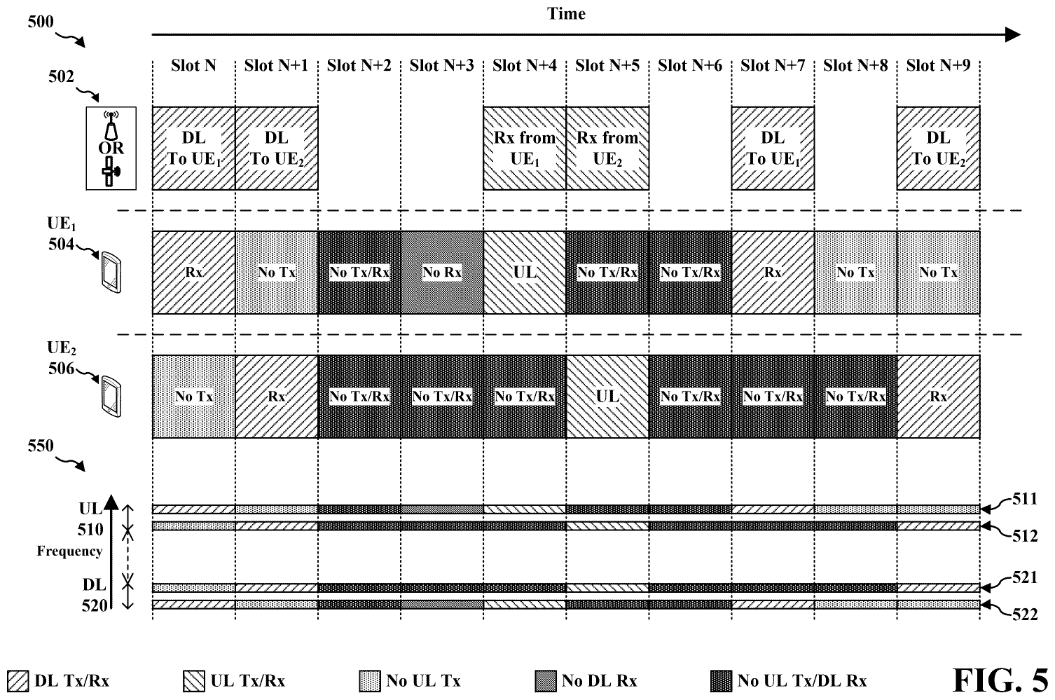

FIG. 5 is a set of diagrams (e.g., diagram 500 and diagram 550) illustrating HD-FDD communication between a base station 502 with two UEs (e.g., UE₁ 504 and UE₂ 506) with different capabilities in accordance with some aspects of the disclosure. Diagram 500 illustrates that a base station 502 may communicate with two UEs, e.g., UE₁ 504 and UE₂ 506, with different switching capabilities in different slots. For example, UE₁ 504 may be capable (e.g., may indicate a capability) of switching within two slots and UE₂ 506 may be capable (e.g., may indicate a capability) of switching within three slots. The different capabilities, in some aspects, may be based on different characteristics of the PLLs or other components of the UEs or may be based on different frequency differences between UL and DL communication. While the description of FIG. 5 assumes that a UE switching capability (e.g., a switching time) is symmetric (i.e., is the same when switching from DL to UL as when switching from UL to DL), in some aspects, a switching time may be asymmetric. For example, in some aspects, a (minimum) switching time for switching between a DL frequency and an UL frequency may be different from a (minimum) switching time for switching between an UL frequency and a DL frequency.

In some aspects, the base station may transmit DL data (e.g., a PDSCH or PDCCH transmission) to UE₁ 504 during a first slot (e.g., slot N). The DL data in slot N, or in an earlier DL transmission, may include scheduling for an UL transmission in slot N+4. Based on the indicated switching and/or transition time, an UL grant in slot N may not be for a slot earlier than slot N+3 to allow for two slots of transition and/or switching between a DL frequency (e.g., DL frequency 522 in a DL frequency range 520) and an UL frequency (e.g., UL frequency 511 in an UL frequency range 510) associated with UE₁ 504. Based on being configured for reception of the DL transmission in slot N (e.g., using the DL frequency 522), UE₁ 504 may not be capable of transmitting in either slot N+1 or slot N+2. Additionally, based on the scheduled UL transmission during slot N+4, UE₁ 504 may be capable of receiving a DL transmission during slot N+1, but may not be capable of reception in either slot N+2 or slot N+3. As indicated, based on the timing of the switch (e.g., whether the switch begins after slot N or after slot N+1), UE₁ 504 may be capable of reception in slot N+1 or may be capable of transmission in slot N+3.

During slot N+4, UE₁ 504 may transmit an UL transmission that is received by the base station 502. During the next two slots, UE₁ 504 may transition from the UL frequency (e.g., UL frequency 511) to the DL frequency (e.g., DL frequency 522) to receive a DL transmission during slot N+7. Because there are only two slots between the UL transmission in slot N+4 and the DL reception in slot N+7, the UE may not be capable of reception or transmission during slot N+5 or during slot N+6. Similarly, after receiving the DL transmission in slot N+7, UE₁ 504 may not be capable of transmission during slot N+8 or during slot N+9.

In some aspects, the base station may transmit DL data (e.g., a PDSCH or PDCCH transmission) to UE₂ 506 during a second slot (e.g., slot N+1). The DL data in slot N+1, or in an earlier DL transmission, may include scheduling for an UL transmission in slot N+5. Based on the indicated switching and/or transition time, an UL grant in slot N+1 may not be for a slot earlier than slot N+5 to allow for three slots of transition and/or switching between a DL frequency (e.g., DL frequency 521) and an UL frequency (e.g., UL frequency 512) associated with UE₂ 506. Based on being configured for reception of the DL transmission in slot N+1 (e.g., using the DL frequency 521), UE₂ 506 may not be capable of transmitting in slot N+2, slot N+3, or slot N+4. Additionally, based on the scheduled UL transmission during slot N+5, UE₂ 506 may not be capable of reception in slot N+2, slot N+3, or slot N+4.

During slot N+5, UE₂ 506 may transmit an UL transmission that is received by the base station 502. During the next three slots, UE₂ 506 may transition from the UL frequency (e.g., UL frequency 512) to the DL frequency (e.g., DL frequency 521) to receive a DL transmission during slot N+9. Because there are only three slots between the UL transmission in slot N+5 and the DL reception in slot N+9, the UE may not be capable of reception or transmission during slot N+6, slot N+7, or slot N+8. While described for UEs using different UL and DL frequencies, in some aspects, a same UL and/or DL frequency may be used by the different UEs. Additionally, while diagram 550 illustrates restrictions on reception or transmission associated with DL, in some aspects, the base station 502 may multiplex communication with multiple UEs such that it can transmit to a first multiplexed UE while a second multiplexed UE is switching frequencies and is unable to receive a DL transmission or transmit an UL transmission.

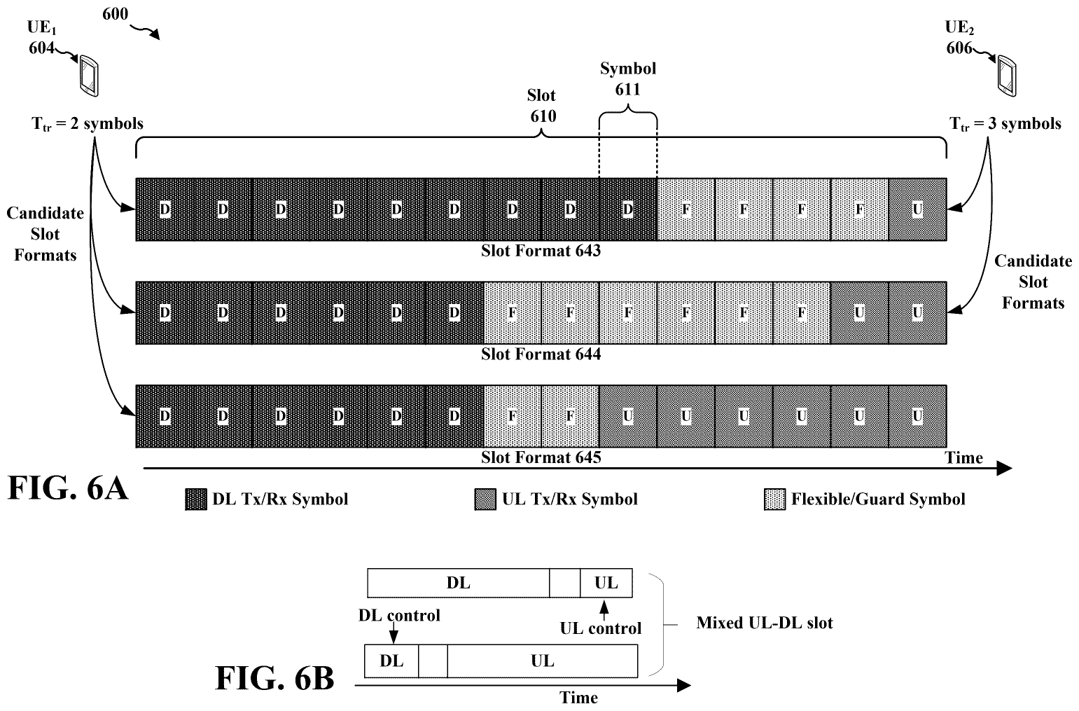

In some aspects, there may be mixed slots where there are uplink and downlink symbols in a same slot. FIG. 6B illustrates examples of mixed slots, showing DL and UL resources. FIG. 6A is a diagram 600 illustrating possible slot structures for sub-slot switching times in accordance with some aspects of the disclosure. Diagram 600 illustrates a set of slot formats for a slot 610 including fourteen symbols 611 where each slot format includes different numbers of DL (“D”) symbols, flexible (“F”) symbols, and UL (“U”) symbols. For example, three slot formats, e.g., slot format 643, slot format 644, and slot format 645, are illustrated that include a first set of “D” symbols followed by different numbers of “F” symbols and ending with one or more “U” symbol. Diagram 600 also illustrates UE₁ 604 that is associated with and/or indicates a capability to switch between a first frequency for DL and a second frequency for UL within two symbols and UE₂ 606 that is associated with and/or indicates a capability to switch between a first frequency for DL and a second frequency for UL within three symbols. Based on the capability, a base station communicating with UE₁ 604 (or UE₂ 606) may determine that slot format 643, slot format 644, and slot format 645 (or slot format 643 and slot format 644) are candidate slot formats for communicating with UE₁ 604 (or UE₂ 606).

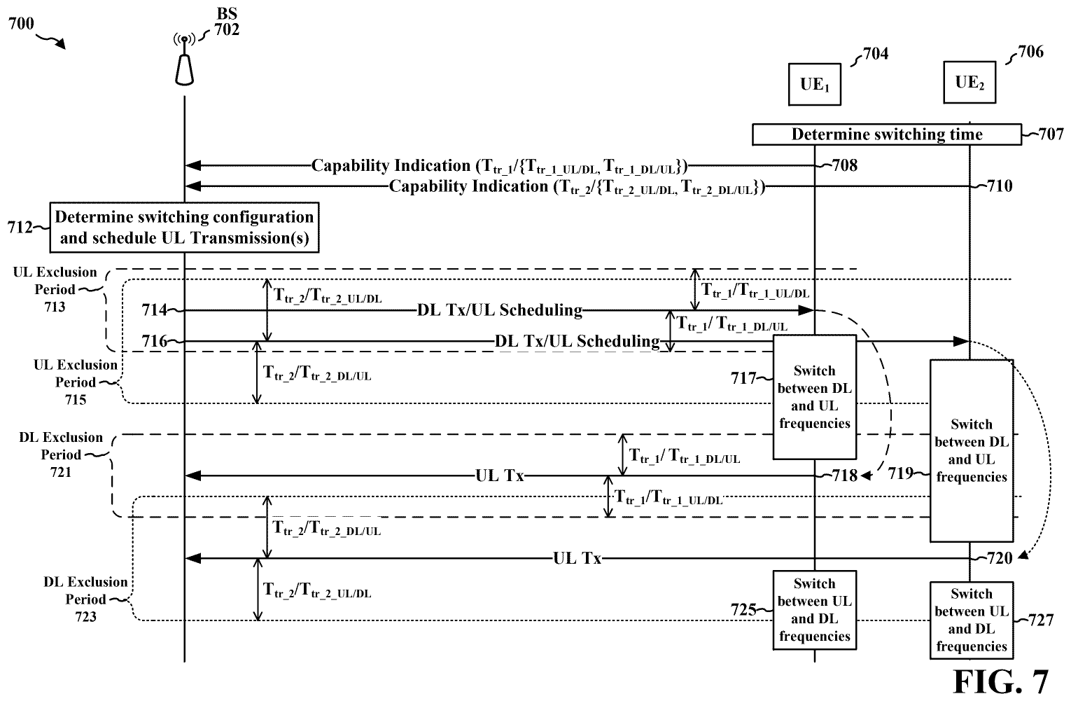

FIG. 7 is a communication flow diagram 700 illustrating a method of wireless communication in accordance with some aspects of the disclosure. The method is illustrated in relation to a base station 702 (e.g., as an example of a network device or network node that may include one or more components of a disaggregated base station) in communication with a first UE (e.g., UE₁ 704) and a second UE (e.g., UE₂ 706) (e.g., as examples of wireless devices). The functions ascribed to the base station 702, in some aspects, may be performed by one or more components of a network entity, a network node, or a network device (a single network entity/node/device or a disaggregated network entity/node/device as described above in relation to FIG. 1). Similarly, the functions ascribed to a UE, in some aspects, may be performed by one or more components of a wireless device supporting communication with a network entity/node/device. Accordingly, references to “transmitting” in the description below may be understood to refer to a first component of the base station 702 (or a UE) outputting (or providing) an indication of the content of the transmission to be transmitted by a different component of the base station 702 (or a UE). Similarly, references to “receiving” in the description below may be understood to refer to a first component of the base station 702 (or a UE) receiving a transmitted signal and outputting (or providing) the received signal (or information based on the received signal) to a different component of the base station 702 (or a UE).

At 707, the UE₁ 704 and the UE₂ 706 may (separately) determine a minimum switching time for a HD-FDD communication based on characteristics of the UE and the frequencies associated with DL and UL communications for the HD-FDD communication (e.g., a frequency difference between carrier frequencies used for the DL and UL transmissions). Determining a minimum switching time at 707, in some aspects, may include determining a first minimum switching time for a transition and/or switch from a first (or third) frequency used for DL communication to a second (or fourth) frequency used for UL communication and determining a second minimum switching time for a transition and/or switch from the second (or fourth) frequency used for UL communication to the first (or third) frequency used for DL communication. In some aspects, the frequencies used for DL communication and UL communication may not be the same for the UE₁ 704 and the UE₂ 706 (e.g., the UE₁ 704 may use a first frequency for DL communication and a second frequency for UL communication and the UE₂ 706 may use a third frequency for DL communication and a fourth frequency for UL communication). The characteristics of the UE may include characteristics of the PLL and VCO of the UE and/or processing times associated with processing an UL grant. The minimum switching time, in some aspects, may be indicated as a number of at least one of slots, symbols, or milliseconds (e.g., X ms, M slots, N symbols, or M slots and N symbols). In some aspects, the indication of the minimum switching time may be an indication of a UE type, category, or classification associated with a minimum time for switching between frequencies. The indication of the UE type or classification, in some aspects, may be associated with a minimum switching time for a plurality of frequency differences (e.g., as a function of the frequency difference such as 1 symbol of switching time for each 500 MHz difference between the DL and UL carrier frequencies, or a set of minimum switching times for a corresponding set of ranges of frequency differences such as 5 symbols for frequency differences between 0 and 1 GHz, 1 slot for frequency differences between 1 GHz and 2 GHz, etc.).

In some aspects, the UE₁ 704 and the UE₂ 706 may (separately) determine a value or index to be used to indicate a time that is at least the minimum switching time, e.g., when the minimum switching time is indicated to be one of a set of candidate values and/or indices (or is indicated based on a larger unit than used to calculate minimum switching time). For example, if a minimum switching time is one slot and six symbols, an index value, or set of index values, indicating a minimum switching time of one slot and eight symbols may be selected from a set of candidate index values, or candidate index value sets, where the set of candidate index values, or candidate index value sets, may be used to indicate minimum switching times of at least one slot and four symbols and one slot and eight symbols (e.g., when using a 4 bit index assigning 2 bits for indicating values of M and 2 bits indicating values of N, where M can take the values 0, 1, 2, or 3 and N can take the values 1, 2, 4, or 8). Or, for the same minimum switching time, if the unit associated with the indication is a slot, the indication may be for 2 slots (e.g., based on a calculation

$$⌈ \frac{\#symbols}{\#symbols / slot} ⌉ ,$$

where the minimum switching time is 20 symbols and there are 14 symbols/slot). In some aspects, using smaller units (e.g., symbols instead of slots) to indicate minimum switching times may increase a probability that a first minimum switching time for a transition and/or switch from a first (or third) frequency used for DL communication to a second (or fourth) frequency used for UL communication may be determined and/or indicated to be different from a second minimum switching time for a transition and/or switch from the second (or fourth) frequency used for UL communication to the first (or third) frequency used for DL communication.

The UE₁ 704 may transmit, and the base station 702 may receive, capability indication 708 indicating a minimum switching and/or transition time (e.g., a symmetric transition time (T_{tr_1}) or a set of asymmetric transition times including a first transition time for transitioning from an UL frequency to a DL frequency (T_{tr_1_UL/DL}) and second transition time for transitioning from a DL frequency to an UL frequency (T_{tr_1_DL/UL})) associated with the UE₁ 704 as discussed above in relation to the determination at 707. The UE₂ 706 may transmit, and the base station 702 may receive, capability indication 710 indicating a minimum switching and/or transition time (e.g., a transition time (T_{tr_2}) or a set of asymmetric transition times including a first transition time for transitioning from an UL frequency to a DL frequency (T_{tr_2_UL/DL}) and second transition time for transitioning from a DL frequency to an UL frequency (T_{tr_2_DL/UL})) associated with the UE₂ 706 as discussed above in relation to the determination at 707. The capability indication 708, in some aspects, may indicate a minimum switching time of two slots (or two symbols) and the capability indication 710, in some aspects, may indicate a minimum switching time of three slots (or three symbols).

Based on the capability indication 708 and/or capability indication 710, the base station 702 may determine, at 712, a switching configuration and schedule UL transmissions for the UE₁ 704 and the UE₂ 706. The base station 702, in some aspects, may transmit DL transmission 714 that may include scheduling information (e.g., an UL grant) for a subsequent UL transmission. Based on the timing of the DL transmission 714 and the capability indication 708, the base station 702 may determine a time period (e.g., UL exclusion period 713 including a first set of slots/symbols (e.g., based on T_{tr_1} or T_{tr_1_UL/DL}) before the DL transmission 714 and a second set of slots/symbols (e.g., based on T_{tr_1} or T_{tr_1_DL/UL}) after the DL transmission 714) during which no UL transmissions will be scheduled. The base station 702, in some aspects, may transmit DL transmission 716 that may include scheduling information (e.g., an UL grant) for a subsequent UL transmission. Based on the timing of the DL transmission 716 and the capability indication 710, the base station 702 may determine a time period (e.g., UL exclusion period 715 including a third set of slots/symbols (e.g., based on T_{tr_2} or T_{tr_2_UL/DL}) before the DL transmission 716 and a fourth set of slots/symbols (e.g., based T_{tr_2} or T_{tr_2_DL/UL}) after the DL transmission 716) during which no UL transmissions will be scheduled. If at least one of the minimum switching times for the UE₁ 704 and the UE₂ 706 are indicated to be less than 13 symbols, the corresponding UL grant(s) may be for a slot format including at least the indicated number of “F” symbols that can be used to transition between a “D” symbol and a “U” symbol.

Based on the UL grant included in DL transmission 714 (or an UL grant received in a previous DL transmission (not shown)), the UE₁ 704 may, at 717, transition and/or switch from a first frequency for DL communication to a second frequency for UL communication (e.g., where the transition and/or switch is expected to take no longer than T_{tr_1} or T_{tr_1_DL/UL}). After the transition and/or switch at 717, the UE₁ 704 may transmit, and the base station 702 may receive, UL transmission 718 via the second frequency. The UL transmission 718, in some aspects, may be surrounded by a DL exclusion period 721 including the second set of slots/symbols (e.g., based on T_{tr_1} or T_{tr_1_DL/UL}) before the UL transmission 718 and the first set of slots/symbols (e.g., based on T_{tr_1} or T_{tr_1_UL/DL}) after the UL transmission 718. In some aspects, the transition to the UL frequency at the UE₁ 704 may begin as early as the end of the DL transmission 714 and no later than the beginning of the DL exclusion period 721. The UE₁ 704, in some aspects, may, at 725, transition back to the DL frequency at the end of the UL transmission 718 (e.g., if no additional UL transmissions are scheduled within the next 4 slots).

Based on the UL grant included in DL transmission 716 (or an UL grant received in a previous DL transmission (not shown)), the UE₂ 706 may, at 719, transition and/or switch from a third frequency for DL communication to a fourth frequency for UL communication (e.g., where the transition and/or switch is expected to take no longer than T_{tr_2} or T_{tr_2_DL/UL}). After the transition and/or switch at 719, the UE₂ 706 may transmit, and the base station 702 may receive, UL transmission 720 via the fourth frequency. The UL transmission 720, in some aspects, may be surrounded by a DL exclusion period 723 including the fourth set of slots/symbols (e.g., based on T_{tr_2} or T_{tr_2_DL/UL}) before the UL transmission 720 and the third set of slots/symbols (e.g., based on T_{tr_2} or T_{tr_2_UL/DL}) after the UL transmission 720. In some aspects, the transition to the UL frequency at the UE₂ 706 may begin as early as the end of the DL transmission 716 and no later than the beginning of the DL exclusion period 723. The UE₂ 706, in some aspects, may, at 727, transition back to the DL frequency at the end of the UL transmission 720 (e.g., if no additional UL transmissions are scheduled within the next 6 slots).

After transmitting the UL transmission 718, the UE₁ 704 may, at 725, transition and/or switch from the second frequency for UL communication to the first frequency for DL communication for reception of a subsequent DL transmission as described in relation to FIGS. 4 and 5. After transmitting the UL transmission 720, the UE₂ 706 may, at 727, transition and/or switch from the fourth frequency for UL communication to the third frequency for DL communication for reception of a subsequent DL transmission as described in relation to FIGS. 4 and 5.

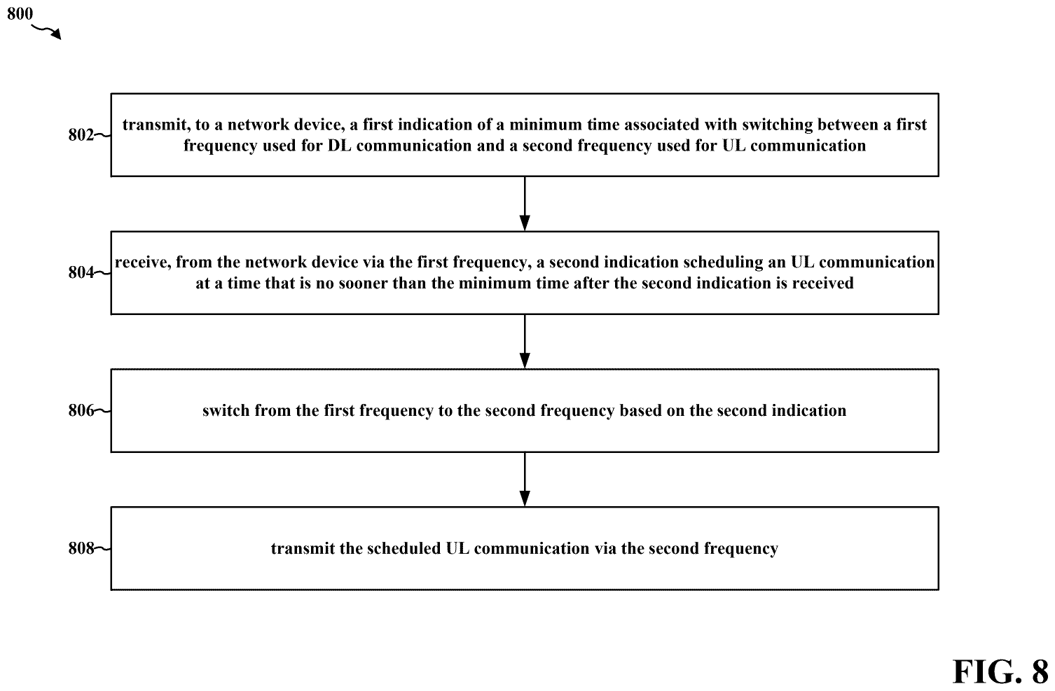

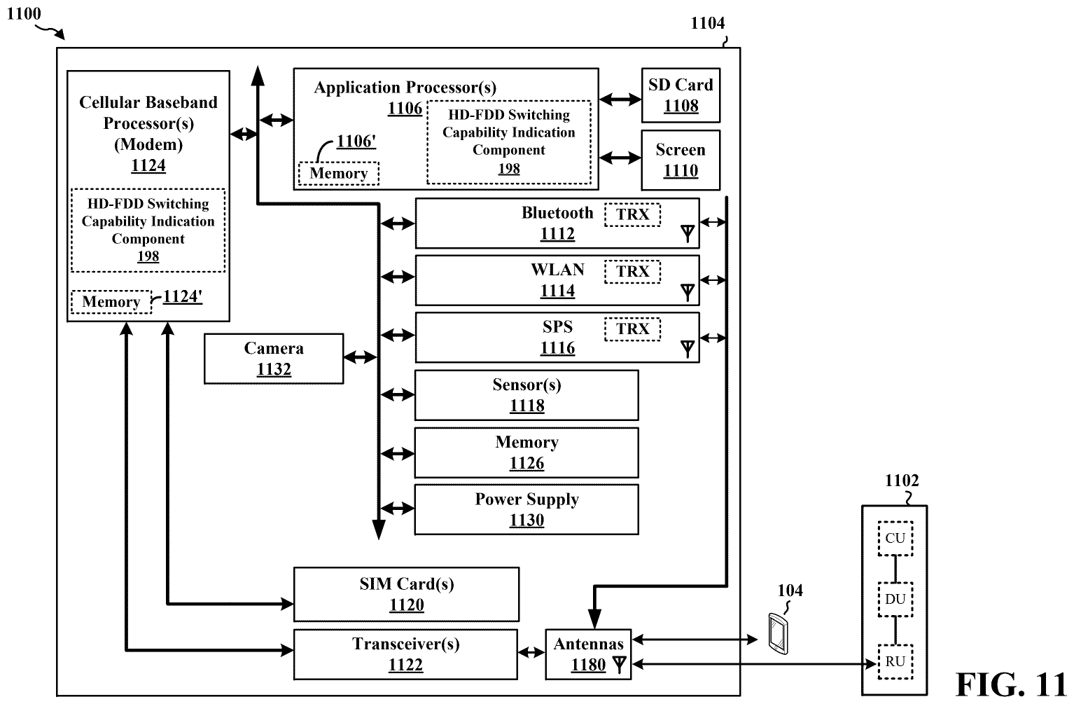

FIG. 8 is a flowchart 800 of a method of wireless communication. The method may be performed by a UE (e.g., the UE 104; the UE₁ 504, 604, 704; the UE₂ 506, 606, 706; the apparatus 1104). At 802, the UE may transmit, to a network device, a first indication of a minimum time associated with switching between a first frequency used for DL communication and a second frequency used for UL communication. For example, 802 may be performed by application processor(s) 1106, cellular baseband processor(s) 1124, transceiver(s) 1122, antenna(s) 1180, and/or HD-FDD switching capability indication component 198 of FIG. 11. In some aspects, the minimum time may be indicated as a number of at least one of slots, symbols, or milliseconds. The first indication, in some aspects, may be an index into an indexed set of candidate minimum times. In some aspects, the first indication may be a set of indexes including a first index associated with a first number of slots and a second index associated with a second number of symbols. The minimum time, in some aspects, may be indicated to be the first number of slots plus the second number of symbols. In some aspects, the first indication may be of a UE category associated with the minimum time. The first frequency and the second frequency, in some aspects, may be associated with a HD-FDD mode of operation. In some aspects, the minimum time may be based on a difference between the first frequency and the second frequency. The minimum time, in some aspects, may be a minimum time associated with both switching from the first frequency used for DL communication to the second frequency used for UL communication and with switching from the second frequency used for UL communication to the first frequency used for DL communication. In some aspects, the minimum time may include a first minimum time associated with switching from the first frequency used for DL communication to the second frequency used for UL communication and a second minimum time associated with switching from the second frequency used for UL communication to the first frequency used for DL communication. For example, referring to FIG. 7, the UE₁ 704 (or the UE₂ 706) may transmit, and the base station 702 may receive, the capability indication 708 (or the capability indication 710).

At 804, the UE may receive, from the network device via the first frequency, a second indication scheduling an UL communication at a time that is no sooner than the minimum time after the second indication is received. For example, 804 may be performed by application processor(s) 1106, cellular baseband processor(s) 1124, transceiver(s) 1122, antenna(s) 1180, and/or HD-FDD switching capability indication component 198 of FIG. 11. In some aspects, the UE does not expect DL communication during a first window preceding a beginning of the scheduled UL communication or during a second window following an end of the scheduled UL communication. The first window and the second window, in some aspects, may span at least the minimum time. The first window, in some aspects, may span at least the first minimum time and the second window may span at least the second minimum time. In some aspects, a flexible slot (for the UL communication) may be scheduled based on the minimum time being indicated to be less than 13 symbols in length. For example, referring to FIG. 7, the base station 702 may transmit, and the UE₁ 704 (or the UE₂ 706) may receive, the DL transmission 714 (or DL transmission 716) including scheduling information (e.g., an UL grant) for a subsequent UL transmission (that is no earlier than the end of the UL exclusion period 713 (or the end of the UL exclusion period 715), i.e., no sooner than the minimum time after the second indication is received).

At 806, the UE may switch from the first frequency to the second frequency based on the second indication. For example, 806 may be performed by application processor(s) 1106, cellular baseband processor(s) 1124, transceiver(s) 1122, antenna(s) 1180, and/or HD-FDD switching capability indication component 198 of FIG. 11. Referring to FIG. 7, for example, the UE₁ 704 (or the UE₂ 706) may, at 717 (or 719), transition and/or switch from a first (third) frequency used for DL communication to a second (fourth) frequency used for UL communication.

At 808, the UE may transmit the scheduled UL communication via the second frequency. For example, 808 may be performed by application processor(s) 1106, cellular baseband processor(s) 1124, transceiver(s) 1122, antenna(s) 1180, and/or HD-FDD switching capability indication component 198 of FIG. 11. Referring to FIG. 7, for example, the UE₁ 704 (or the UE₂ 706) may transmit and the base station 702 may receive, the UL transmission 718 (or the UL transmission 720) via the second (or the fourth) frequency.

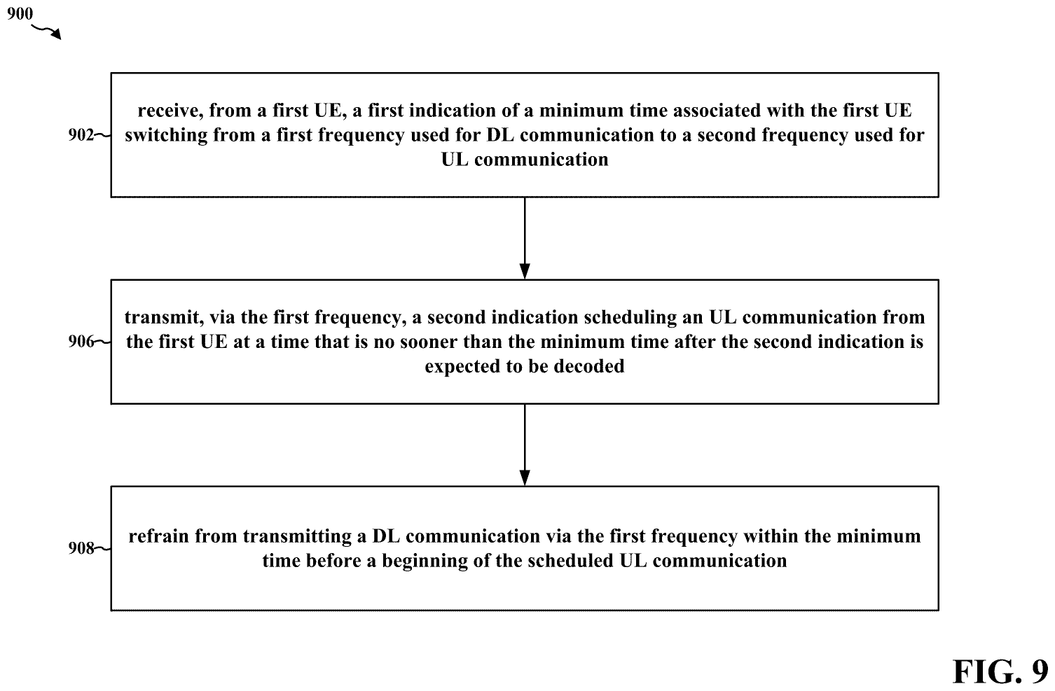

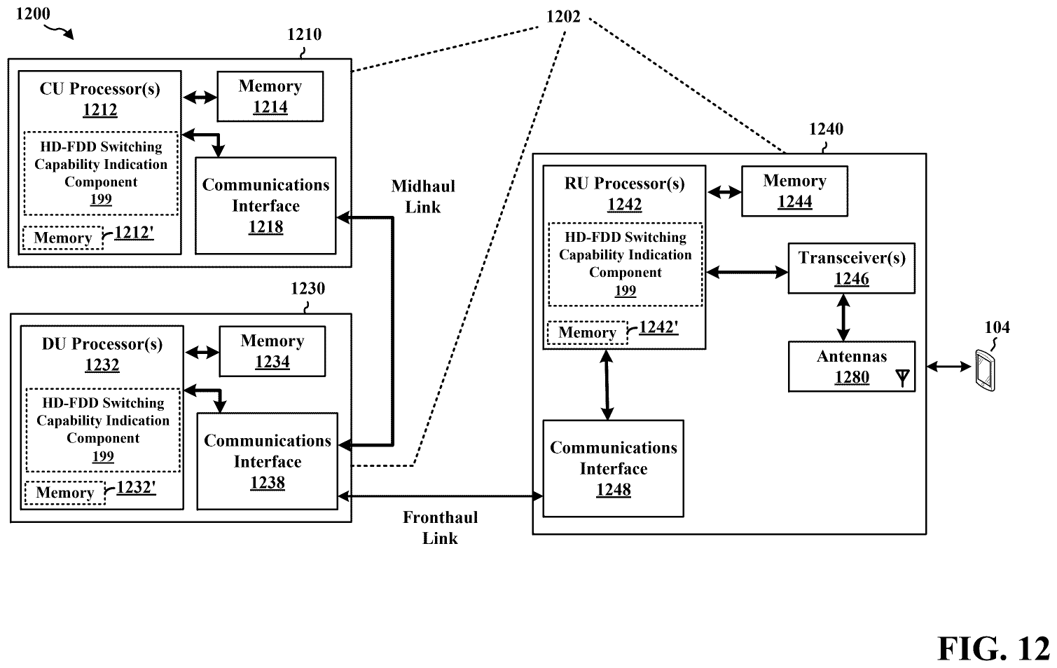

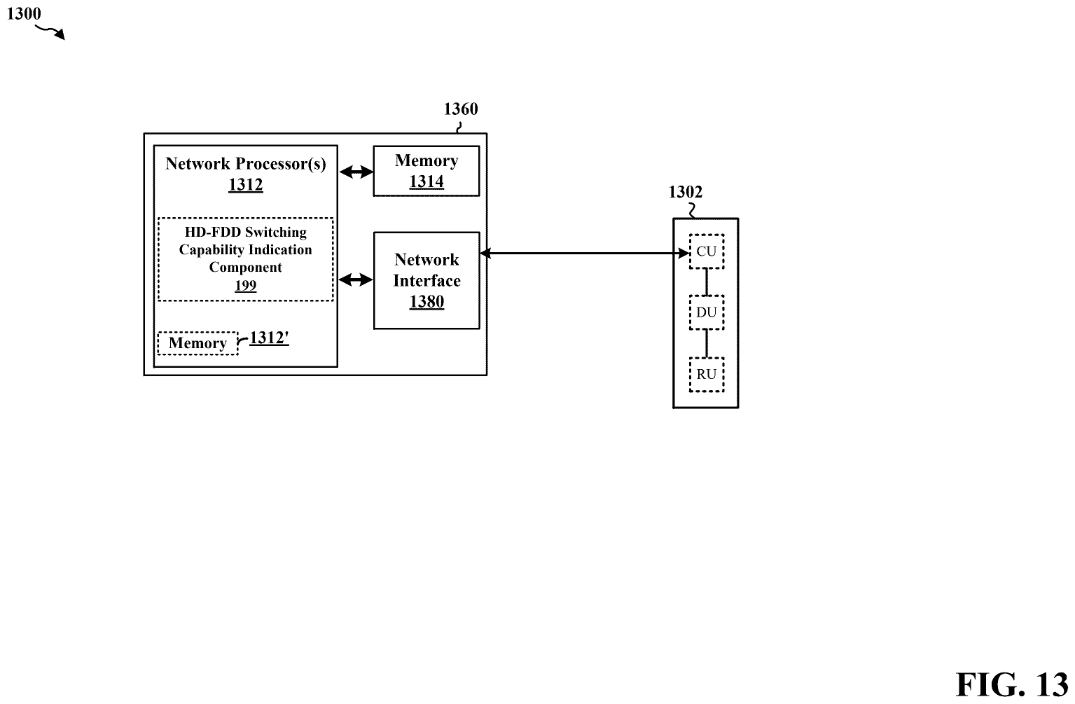

FIG. 9 is a flowchart 900 of a method of wireless communication. The method may be performed by a network device and/or a network node such as a base station (e.g., the base station 102, 502, 702; the network entity 1102, 1202, 1360). At 902, the base station may receive, from a first UE, a first indication of a minimum time associated with the first UE switching between a first frequency used for DL communication and a second frequency used for UL communication. For example, 902 may be performed by CU processor(s) 1212, DU processor(s) 1232, RU processor(s) 1242, transceiver(s) 1246, antenna(s) 1280, network processor 1312, network interface 1380, and/or HD-FDD switching capability indication component 199 of FIGS. 12 and 13. In some aspects, the minimum time may be indicated as a number of at least one of slots, symbols, or milliseconds. The first indication, in some aspects, may be an index into an indexed set of candidate minimum times. In some aspects, the first indication may be a set of indexes including a first index associated with a first number of slots and a second index associated with a second number of symbols. The minimum time, in some aspects, may be indicated to be the first number of slots plus the second number of symbols. In some aspects, the first indication may be of a UE category associated with the minimum time. The first frequency and the second frequency, in some aspects, may be associated with a HD-FDD mode of operation. In some aspects, the minimum time may be based on a difference between the first frequency and the second frequency. The minimum time, in some aspects, may be a minimum time associated with both switching from the first frequency used for DL communication to the second frequency used for UL communication and with switching from the second frequency used for UL communication to the first frequency used for DL communication. In some aspects, the minimum time may include a first minimum time associated with switching from the first frequency used for DL communication to the second frequency used for UL communication and a second minimum time associated with switching from the second frequency used for UL communication to the first frequency used for DL communication. For example, referring to FIG. 7, the UE₁ 704 (or the UE₂ 706) may transmit, and the base station 702 may receive, the capability indication 708 (or the capability indication 710).

In some aspects, the base station may determine if the minimum time indicated by the first indication is longer (or greater) than 13 symbols. If the base station determines that the minimum time indicated by the first indication is 13 symbols or shorter, in some aspects, the base station may schedule a flexible slot (or may be capable of scheduling a flexible slot) in association with the first UE based on the minimum time being indicated to be less than 13 symbols in length. In some aspects, scheduling the flexible slot may include selecting a slot structure and/or format from a plurality of slot structures and/or formats including zero or more of each of D, F, and/or U symbols (e.g., from a set of candidate slot structures and/or formats including slot formats including only D symbols, only F symbols, only U symbols, or a combination of two or more of D, F, and U symbols such as the slot formats illustrated in FIG. 6A). If the base station determines that the minimum time indicated by the first indication is longer (or greater) than 13 symbols (e.g., that a minimum time for switching is at least 1 slot), in some aspects, the base station may schedule an UL slot in association with the first UE based on the minimum time being indicated to be longer than 13 symbols in length. Referring to FIG. 7, for example, based on the capability indication 708 and/or capability indication 710 (e.g., whether the minimum switching and/or transition time allows for sub-slot transitions associated with scheduling flexible symbols), the base station 702 may determine, at 712, a switching configuration and schedule UL transmissions for the UE₁ 704 and the UE₂ 706.

At 906, the base station may transmit, via the first frequency, a second indication scheduling an UL communication from the first UE at a time that is no sooner than the minimum time after the second indication is expected to be received. For example, 906 may be performed by CU processor(s) 1212, DU processor(s) 1232, RU processor(s) 1242, transceiver(s) 1246, antenna(s) 1280, network processor 1312, network interface 1380, and/or HD-FDD switching capability indication component 199 of FIGS. 12 and 13. For example, referring to FIG. 7, the base station 702 may transmit, and the UE₁ 704 (or the UE₂ 706) may receive, the DL transmission 714 (or DL transmission 716) including scheduling information (e.g., an UL grant) for a subsequent UL transmission (that is no earlier than the end of the UL exclusion period 713 (or the end of the UL exclusion period 715), i.e., no sooner than the minimum time, e.g., T_{tr_1}/T_{tr_1_DL/UL} (or T_{tr_2}/T_{tr_2_DL/UL}), after the second indication is received).

At 908, the base station may refrain from transmitting a DL communication via the first frequency within the minimum time before a beginning of the scheduled UL communication. For example, 908 may be performed by CU processor(s) 1212, DU processor(s) 1232, RU processor(s) 1242, transceiver(s) 1246, antenna(s) 1280, network processor 1312, network interface 1380, and/or HD-FDD switching capability indication component 199 of FIGS. 12 and 13. In some aspects, the minimum time is the first minimum time associated with switching from the first frequency used for DL communication to the second frequency used for UL communication. For example, referring to FIG. 7, the base station 702 may refrain from transmitting a DL transmission, and the UE₁ 704 (or the UE₂ 706) may not expect to receive, a DL transmission within the DL exclusion period 721 (or the DL exclusion period 723) before the UL transmission 718 (or the UL transmission 720), i.e., during a window before the scheduled UL transmission that spans at least the minimum time or the first minimum time (or the third minimum time), e.g., T_{tr_1}/T_{tr_1_DL/UL} (or T_{tr_2}/T_{tr_2_DL/UL}).

In some aspects, the base station may refrain from transmitting the DL communication via the first frequency within the minimum time after an end of the scheduled UL communication. In some aspects, the minimum time is the second minimum time associated with switching from the second frequency used for UL communication to the first frequency used for DL communication. For example, referring to FIG. 7, the base station 702 may refrain from transmitting a DL transmission, and the UE₁ 704 (or the UE₂ 706) may not expect to receive, a DL transmission within the DL exclusion period 721 (or the DL exclusion period 723) after the UL transmission 718 (or the UL transmission 720), i.e., during a window after the scheduled UL transmission that spans at least the minimum time or the second minimum time (or the fourth minimum time), e.g., T_{tr_1}/T_{tr_1_UL/DL} (or T_{tr_2}/T_{tr_2_UL/DL}).

While FIG. 9 is described above in relation to a first UE, some or all of the operations may be performed for each of a plurality of UEs communicating with the base station as described in relation to FIGS. 4-7. For example, the base station may receive, from a second UE, a third indication of an additional minimum time (or an additional set of minimum times) associated with the second UE switching between a third frequency used for DL communication and a fourth frequency used for UL communication, transmit, via the third frequency, a fourth indication scheduling an additional UL communication from the second UE at an additional time that is no sooner than the additional minimum time (or a third minimum time in the additional set of minimum times) after the fourth indication is expected to be decoded, and refrain from transmitting an additional DL communication via the third frequency within the additional minimum time (or a fourth minimum time in the additional set of minimum times) before a starting time of the additional scheduled UL communication.

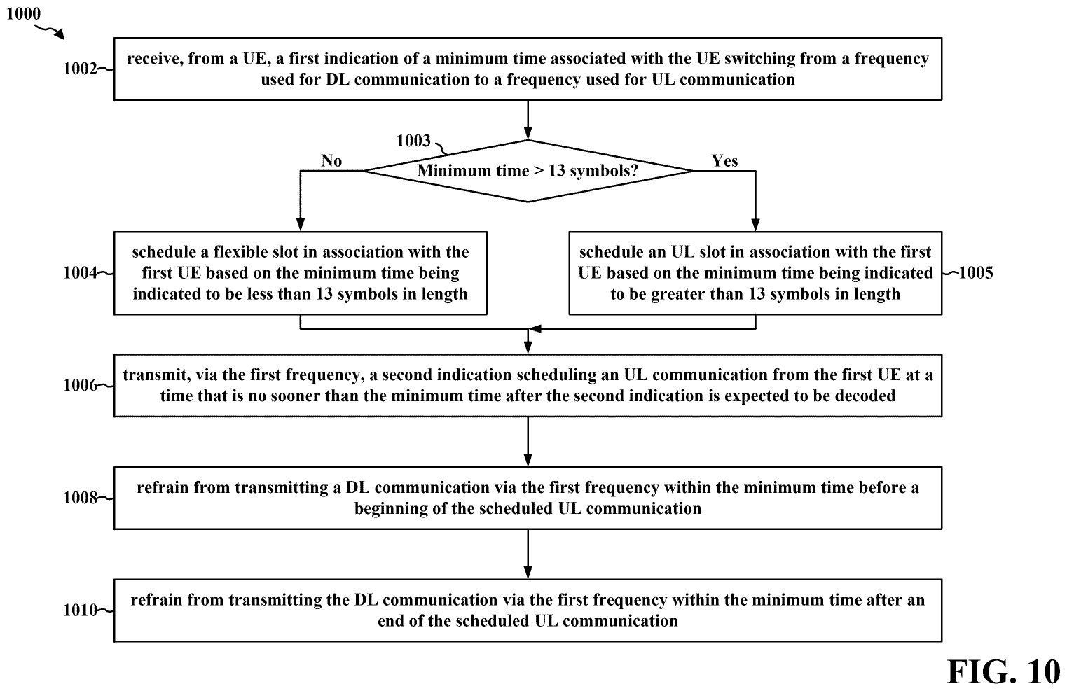

FIG. 10 is a flowchart 1000 of a method of wireless communication. The method may be performed by a network device and/or a network node such as a base station (e.g., the base station 102, 502, 702; the network entity 1102, 1202, 1360). At 1002, the base station may receive, from a first UE, a first indication of a minimum time associated with the first UE switching between a first frequency used for DL communication and a second frequency used for UL communication. For example, 1002 may be performed by CU processor(s) 1212, DU processor(s) 1232, RU processor(s) 1242, transceiver(s) 1246, antenna(s) 1280, network processor 1312, network interface 1380, and/or HD-FDD switching capability indication component 199 of FIGS. 12 and 13. In some aspects, the minimum time may be indicated as a number of at least one of slots, symbols, or milliseconds. The first indication, in some aspects, may be an index into an indexed set of candidate minimum times. In some aspects, the first indication may be a set of indexes including a first index associated with a first number of slots and a second index associated with a second number of symbols. The minimum time, in some aspects, may be indicated to be the first number of slots plus the second number of symbols. In some aspects, the first indication may be of a UE category associated with the minimum time. The first frequency and the second frequency, in some aspects, may be associated with a HD-FDD mode of operation. In some aspects, the minimum time may be based on a difference between the first frequency and the second frequency. The minimum time, in some aspects, may be a minimum time associated with both switching from the first frequency used for DL communication to the second frequency used for UL communication and with switching from the second frequency used for UL communication to the first frequency used for DL communication. In some aspects, the minimum time may include a first minimum time associated with switching from the first frequency used for DL communication to the second frequency used for UL communication and a second minimum time associated with switching from the second frequency used for UL communication to the first frequency used for DL communication. For example, referring to FIG. 7, the UE₁ 704 (or the UE₂ 706) may transmit, and the base station 702 may receive, the capability indication 708 (or the capability indication 710).

At 1003, the base station may determine if the minimum time indicated by the first indication is longer (or greater) than 13 symbols. If, at 1003, the base station determines that the minimum time indicated by the first indication is 13 symbols or shorter, in some aspects, the base station may, at 1004, schedule a flexible slot (or may be capable of scheduling a flexible slot) in association with the first UE based on the minimum time being indicated to be less than 13 symbols in length. In some aspects, scheduling the flexible slot may include selecting a slot structure and/or format from a plurality of slot structures and/or formats including zero or more of each of D, F, and/or U symbols (e.g., from a set of candidate slot structures and/or formats including slot formats including only D symbols, only F symbols, only U symbols, or a combination of two or more of D, F, and U symbols such as the slot formats illustrated in FIG. 6A). If, at 1003, the base station determines that the minimum time indicated by the first indication is longer (or greater) than 13 symbols (e.g., that a minimum time for switching is at least 1 slot), in some aspects, the base station may, at 1005, schedule an UL slot in association with the first UE based on the minimum time being indicated to be longer than 13 symbols in length. For example, 1003, 1004, and 1005 may be performed by CU processor(s) 1212, DU processor(s) 1232, RU processor(s) 1242, transceiver(s) 1246, antenna(s) 1280, network processor 1312, network interface 1380, and/or HD-FDD switching capability indication component 199 of FIGS. 12 and 13. Referring to FIG. 7, for example, based on the capability indication 708 and/or capability indication 710 (e.g., whether the minimum switching and/or transition time allows for sub-slot transitions associated with scheduling flexible symbols), the base station 702 may determine, at 712, a switching configuration and schedule UL transmissions for the UE₁ 704 and the UE₂ 706.

At 1006, the base station may transmit, via the first frequency, a second indication scheduling an UL communication from the first UE at a time that is no sooner than the minimum time after the second indication is expected to be received. For example, 1006 may be performed by CU processor(s) 1212, DU processor(s) 1232, RU processor(s) 1242, transceiver(s) 1246, antenna(s) 1280, network processor 1312, network interface 1380, and/or HD-FDD switching capability indication component 199 of FIGS. 12 and 13. For example, referring to FIG. 7, the base station 702 may transmit, and the UE₁ 704 (or the UE₂ 706) may receive, the DL transmission 714 (or DL transmission 716) including scheduling information (e.g., an UL grant) for a subsequent UL transmission (that is no earlier than the end of the UL exclusion period 713 (or the end of the UL exclusion period 715), i.e., no sooner than the minimum time, e.g., Ti/T_{tr_1_DL/UL} (or T_{tr_2}/T_{tr_2_DL/UL}), after the second indication is received).

At 1008, the base station may refrain from transmitting a DL communication via the first frequency within the minimum time before a beginning of the scheduled UL communication. For example, 1008 may be performed by CU processor(s) 1212, DU processor(s) 1232, RU processor(s) 1242, transceiver(s) 1246, antenna(s) 1280, network processor 1312, network interface 1380, and/or HD-FDD switching capability indication component 199 of FIGS. 12 and 13. In some aspects, the minimum time is the first minimum time associated with switching from the first frequency used for DL communication to the second frequency used for UL communication. For example, referring to FIG. 7, the base station 702 may refrain from transmitting a DL transmission, and the UE₁ 704 (or the UE₂ 706) may not expect to receive, a DL transmission within the DL exclusion period 721 (or the DL exclusion period 723) before the UL transmission 718 (or the UL transmission 720), i.e., during a window before the scheduled UL transmission that spans at least the minimum time or the first minimum time (or the third minimum time), e.g., T_{tr_1}/T_{tr_1_DL/UL} (or T_{tr_2}/T_{tr_2_DL/UL}).

At 1010, the base station may refrain from transmitting the DL communication via the first frequency within the minimum time after an end of the scheduled UL communication. For example, 1010 may be performed by CU processor(s) 1212, DU processor(s) 1232, RU processor(s) 1242, transceiver(s) 1246, antenna(s) 1280, network processor 1312, network interface 1380, and/or HD-FDD switching capability indication component 199 of FIGS. 12 and 13. In some aspects, the minimum time is the second minimum time associated with switching from the second frequency used for UL communication to the first frequency used for DL communication. For example, referring to FIG. 7, the base station 702 may refrain from transmitting a DL transmission, and the UE₁ 704 (or the UE₂ 706) may not expect to receive, a DL transmission within the DL exclusion period 721 (or the DL exclusion period 723) after the UL transmission 718 (or the UL transmission 720), i.e., during a window after the scheduled UL transmission that spans at least the minimum time or the second minimum time (or the fourth minimum time), e.g., T_{tr_1}/T_{tr_1_UL/DL} (or T_{tr_2}/T_{tr_2_UL/DL}).

While FIG. 10 is described above in relation to a first UE, some or all of the operations may be performed for each of a plurality of UEs communicating with the base station as described in relation to FIGS. 4-7. For example, the base station may receive, from a second UE, a third indication of an additional minimum time (or an additional set of minimum times) associated with the second UE switching between a third frequency used for DL communication and a fourth frequency used for UL communication, transmit, via the third frequency, a fourth indication scheduling an additional UL communication from the second UE at an additional time that is no sooner than the additional minimum time (or a third minimum time in the additional set of minimum times) after the fourth indication is expected to be decoded, and refrain from transmitting an additional DL communication via the third frequency within the additional minimum time (or a fourth minimum time in the additional set of minimum times) before a starting time of the additional scheduled UL communication.

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include at least one cellular baseband processor 1124 (also referred to as a modem) coupled to one or more transceivers 1122 (e.g., cellular RF transceiver). The cellular baseband processor(s) 1124 may include at least one on-chip memory 1124′. In some aspects, the apparatus 1104 may further include one or more subscriber identity modules (SIM) cards 1120 and at least one application processor 1106 coupled to a secure digital (SD) card 1108 and a screen 1110. The application processor(s) 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize one or more antennas 1180 for communication. The cellular baseband processor(s) 1124 communicates through the transceiver(s) 1122 via the one or more antennas 1180 with the UE 104 and/or with an RU associated with a network entity 1102. The cellular baseband processor(s) 1124 and the application processor(s) 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor(s) 1124 and the application processor(s) 1106 are each responsible for general processing, including the execution of software stored on the computer-readable medium/memory. The software, when executed by the cellular baseband processor(s) 1124/application processor(s) 1106, causes the cellular baseband processor(s) 1124/application processor(s) 1106 to perform the various functions described supra. The computer-readable medium/memory may also be used for storing data that is manipulated by the cellular baseband processor(s) 1124/application processor(s) 1106 when executing software. The cellular baseband processor(s) 1124/application processor(s) 1106 may be a component of the UE 350 and may include the at least one memory 360 and/or at least one of the TX processor 368, the RX processor 356, and the controller/processor 359. In one configuration, the apparatus 1104 may be at least one processor chip (modem and/or application) and include just the cellular baseband processor(s) 1124 and/or the application processor(s) 1106, and in another configuration, the apparatus 1104 may be the entire UE (e.g., see UE 350 of FIG. 3) and include the additional modules of the apparatus 1104.

As discussed supra, the HD-FDD switching capability indication component 198 may be configured to transmit, to a network device, a first indication of a minimum time associated with switching between a first frequency used for DL communication and a second frequency used for UL communication, receive, from the network device via the first frequency, a second indication scheduling an UL communication at a time that is no sooner than the minimum time after the second indication is received, switch from the first frequency to the second frequency based on the second indication, and transmit the scheduled UL communication via the second frequency. The HD-FDD switching capability indication component 198 may be within the cellular baseband processor(s) 1124, the application processor(s) 1106, or both the cellular baseband processor(s) 1124 and the application processor(s) 1106. The HD-FDD switching capability indication component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1104 may include a variety of components configured for various functions. In one configuration, the apparatus 1104, and in particular the cellular baseband processor(s) 1124 and/or the application processor(s) 1106, may include means for transmitting, to a network device, a first indication of a minimum time associated with switching between a first frequency used for downlink (DL) communication and a second frequency used for uplink (UL) communication. The apparatus 1104, and in particular the cellular baseband processor(s) 1124 and/or the application processor(s) 1106, may include means for receiving, from the network device via the first frequency, a second indication scheduling an UL communication at a time that is no sooner than the minimum time after the second indication is received. The apparatus 1104, and in particular the cellular baseband processor(s) 1124 and/or the application processor(s) 1106, may include means for switching from the first frequency to the second frequency based on the second indication. The apparatus 1104, and in particular the cellular baseband processor(s) 1124 and/or the application processor(s) 1106, may include means for transmitting the scheduled UL communication via the second frequency. The apparatus 1104 may further include means for performing any of the aspects described in connection with the flowcharts in FIG. 8, and/or performed by the UE in the communication flow of FIG. 7. The means may be the HD-FDD switching capability indication component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the HD-FDD switching capability indication component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include at least one CU processor 1212. The CU processor(s) 1212 may include on-chip memory 1212′. In some aspects, the CU 1210 may further include additional memory modules 1214 and a communications interface 1218. The CU 1210 communicates with the DU 1230 through a midhaul link, such as an F1 interface. The DU 1230 may include at least one DU processor 1232. The DU processor(s) 1232 may include on-chip memory 1232′. In some aspects, the DU 1230 may further include additional memory modules 1234 and a communications interface 1238. The DU 1230 communicates with the RU 1240 through a fronthaul link. The RU 1240 may include at least one RU processor 1242. The RU processor(s) 1242 may include on-chip memory 1242′. In some aspects, the RU 1240 may further include additional memory modules 1244, one or more transceivers 1246, one or more antennas 1280, and a communications interface 1248. The RU 1240 communicates with the UE 104. The on-chip memory 1212′, 1232′, 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the HD-FDD switching capability indication component 199 may be configured to receive, from a first UE, a first indication of a minimum time associated with the first UE switching from a first frequency used for DL communication to a second frequency used for UL communication, transmit, via the first frequency, a second indication scheduling an UL communication from the first UE at a time that is no sooner than the minimum time after the second indication is expected to be decoded, and refrain from transmitting a DL communication via the first frequency within the minimum time before a beginning of the scheduled UL communication. The HD-FDD switching capability indication component 199 may be within one or more processors of one or more of the CU 1210, DU 1230, and the RU 1240. The HD-FDD switching capability indication component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1202 may include a variety of components configured for various functions. In one configuration, the network entity 1202 may include means for receiving, from a first user equipment (UE), a first indication of a minimum time associated with the first UE switching from a first frequency used for downlink (DL) communication to a second frequency used for uplink (UL) communication. The network entity 1202 may include means for transmitting, via the first frequency, a second indication scheduling an UL communication from the first UE at a time that is no sooner than the minimum time after the second indication is expected to be received. The network entity 1202 may include means for refraining from transmitting a DL communication via the first frequency within the minimum time before a beginning of the scheduled UL communication. The network entity 1202 may include means for scheduling a flexible slot in association with the first UE based on the minimum time being indicated to be less than 13 symbols in length. The network entity 1202 may include means for refraining from transmitting the DL communication via the first frequency within the minimum time after an end of the scheduled UL communication. The network entity 1202 may include means for receiving, from a second UE, a third indication of an additional minimum time associated with the second UE switching from a third frequency used for DL communication to a fourth frequency used for UL communication. The network entity 1202 may include means for transmitting, via the third frequency, a fourth indication scheduling an additional UL communication from the second UE at an additional time that is no sooner than the additional minimum time after the fourth indication is expected to be decoded. The network entity 1202 may include means for refraining from transmitting an additional DL communication via the third frequency within the additional minimum time before a starting time of the additional scheduled UL communication. The network entity 1202 may further include means for performing any of the aspects described in connection with the flowcharts in FIGS. 9 and 10, and/or performed by the base station in the communication flow of FIG. 7. The means may be the HD-FDD switching capability indication component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means or as described in relation to FIGS. 9 and 10.

FIG. 13 is a diagram 1300 illustrating an example of a hardware implementation for a network entity 1360. In one example, the network entity 1360 may be within the core network 120. The network entity 1360 may include at least one network processor 1312. The network processor(s) 1312 may include on-chip memory 1312′. In some aspects, the network entity 1360 may further include additional memory modules 1314. The network entity 1360 communicates via the network interface 1380 directly (e.g., backhaul link) or indirectly (e.g., through a RIC) with the CU 1302. The on-chip memory 1312′ and the additional memory modules 1314 may each be considered a computer-readable medium/memory. Each computer-readable medium/memory may be non-transitory. The network processor(s) 1312 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the HD-FDD switching capability indication component 199 may be configured to receive, from a first UE, a first indication of a minimum time associated with the first UE switching from a first frequency used for DL communication to a second frequency used for UL communication, transmit, via the first frequency, a second indication scheduling an UL communication from the first UE at a time that is no sooner than the minimum time after the second indication is expected to be decoded, and refrain from transmitting a DL communication via the first frequency within the minimum time before a beginning of the scheduled UL communication. The HD-FDD switching capability indication component 199 may be within the network processor(s) 1312. The HD-FDD switching capability indication component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1360 may include a variety of components configured for various functions. In one configuration, the network entity 1360 may include means for receiving, from a first user equipment (UE), a first indication of a minimum time associated with the first UE switching from a first frequency used for downlink (DL) communication to a second frequency used for uplink (UL) communication. The network entity 1360 may include means for transmitting, via the first frequency, a second indication scheduling an UL communication from the first UE at a time that is no sooner than the minimum time after the second indication is expected to be received. The network entity 1360 may include means for refraining from transmitting a DL communication via the first frequency within the minimum time before a beginning of the scheduled UL communication. The network entity 1360 may include means for scheduling a flexible slot in association with the first UE based on the minimum time being indicated to be less than 13 symbols in length. The network entity 1360 may include means for refraining from transmitting the DL communication via the first frequency within the minimum time after an end of the scheduled UL communication. The network entity 1360 may include means for receiving, from a second UE, a third indication of an additional minimum time associated with the second UE switching from a third frequency used for DL communication to a fourth frequency used for UL communication. The network entity 1360 may include means for transmitting, via the third frequency, a fourth indication scheduling an additional UL communication from the second UE at an additional time that is no sooner than the additional minimum time after the fourth indication is expected to be decoded. The network entity 1360 may include means for refraining from transmitting an additional DL communication via the third frequency within the additional minimum time before a starting time of the additional scheduled UL communication. The means may be the HD-FDD switching capability indication component 199 of the network entity 1360 configured to perform the functions recited by the means or as described in relation to FIGS. 9 and 10.

Various aspects relate generally to a UE capability for indicating to a base station how much time it takes for the UE to switch between transmission and reception (or vice versa) in association with FR2 (NTN) HD-FDD operation. In some examples, a wireless device may be configured to transmit, to a network device, a first indication of a minimum time associated with switching between a first frequency used for DL communication and a second frequency used for UL communication, receive, from the network device via the first frequency, a second indication scheduling an UL communication at a time that is no sooner than the minimum time after the second indication is received, switch from the first frequency to the second frequency based on the second indication, and transmit the scheduled UL communication via the second frequency. In some examples, a base station may be configured to receive, from a first UE, a first indication of a minimum time associated with the first UE switching from a first frequency used for DL communication to a second frequency used for UL communication, transmit, via the first frequency, a second indication scheduling an UL communication from the first UE at a time that is no sooner than the minimum time after the second indication is expected to be decoded, and refrain from transmitting a DL communication via the first frequency within the minimum time before a beginning of the scheduled UL communication.

Particular aspects of the subject matter described in this disclosure can be implemented to realize one or more of the following potential advantages. In some examples, by having a UE indicate a switching and/or transition time to a base station, the described techniques can be used to appropriately schedule UL and/or DL transmission despite different UEs having different capabilities for switching between frequencies and avoid introducing an overly long time between a DL transmission and a subsequent UL transmission (or vice versa) that accommodates a worst case, or average, switching and/or transition time.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: transmitting, to a network device, a first indication of a minimum time associated with switching between a first frequency used for downlink (DL) communication and a second frequency used for uplink (UL) communication; receiving, from the network device via the first frequency, a second indication scheduling an UL communication at a time that is no sooner than the minimum time after the second indication is received; switching from the first frequency to the second frequency based on the second indication; and transmitting the scheduled UL communication via the second frequency.

Aspect 2 is the method of aspect 1, wherein the minimum time is indicated as a number of at least one of slots, symbols, or milliseconds.

Aspect 3 is the method of any of aspects 1 and 2, wherein the first indication is an index into an indexed set of candidate minimum times.

Aspect 4 is the method of any of aspects 1 to 3, wherein the first indication is a set of indexes comprising a first index associated with a first number of slots and a second index associated with a second number of symbols, wherein the minimum time is indicated to be the first number of slots plus the second number of symbols.

Aspect 5 is the method of any of aspects 1 and 2, wherein the first indication is of a UE category associated with the minimum time.

Aspect 6 is the method of any of aspects 1 to 5, wherein the first frequency and the second frequency are associated with a half-duplex (HD) frequency division duplexing (FDD) (HD-FDD) mode of operation.

Aspect 7 is the method of any of aspects 1 to 6, wherein the minimum time is based on a difference between the first frequency and the second frequency.

Aspect 8 is the method of any of aspects 1 to 7, wherein the minimum time is a minimum time associated with both switching from the first frequency used for DL communication to the second frequency used for UL communication and switching from the second frequency used for UL communication to the first frequency used for DL communication, wherein the UE does not expect DL communication during a first window preceding a beginning of the scheduled UL communication or during a second window following an end of the scheduled UL communication, wherein the first window and the second window span at least the minimum time.

Aspect 9 is the method of any of aspects 1 to 8, wherein a flexible slot is scheduled based on the minimum time.

Aspect 10 is the method of any of aspects 1 to 7 and 9, wherein the first indication indicates a first minimum time associated with switching from the first frequency used for DL communication to the second frequency used for UL communication and a second minimum time associated with switching from the second frequency used for UL communication to the first frequency used for DL communication and the UE does not expect DL communication during a first window spanning at least the first minimum time preceding a beginning of the scheduled UL communication or during a second window spanning at least the second minimum time following an end of the scheduled UL communication.

Aspect 11 is a method of wireless communication at a network device, comprising: receiving, from a first user equipment (UE), a first indication of a minimum time associated with the first UE switching between a first frequency used for downlink (DL) communication and a second frequency used for uplink (UL) communication; transmitting, via the first frequency, a second indication scheduling an UL communication from the first UE at a time that is no sooner than the minimum time after the second indication is expected to be received; and refraining from transmitting a DL communication via the first frequency within the minimum time before a beginning of the scheduled UL communication.

Aspect 12 is the method of aspect 11, wherein the minimum time is indicated as a number of at least one of slots, symbols, or milliseconds.

Aspect 13 is the method of any of aspects 11 and 12, wherein the first indication is an index into an indexed set of candidate minimum times.

Aspect 14 is the method of any of aspects 11 to 13, wherein the first indication is a set of indexes comprising a first index associated with a first number of slots and a second index associated with a second number of symbols, wherein the minimum time is indicated to be the first number of slots plus the second number of symbols.

Aspect 15 is the method of any of aspects 11 to 12, wherein the first indication is of a UE category associated with the minimum time.

Aspect 16 is the method of any of aspects 11 to 15, wherein the first frequency and the second frequency are associated with a half-duplex (HD) frequency division duplexing (FDD) (HD-FDD) mode of operation.

Aspect 17 is the method of any of aspects 11 to 16, wherein the minimum time is based on a difference between the first frequency and the second frequency.

Aspect 18 is the method of any of aspects 11 to 17, further comprising: refraining from transmitting the DL communication via the first frequency within the minimum time after an end of the scheduled UL communication.

Aspect 19 is the method of any of aspects 11 to 18, the method further comprising: scheduling a flexible slot in association with the first UE based on the minimum time being indicated to be less than 13 symbols in length.

Aspect 20 is the method of any of aspects 11 to 19 further comprising: receiving, from a second UE, a third indication of an additional minimum time associated with the second UE switching from a third frequency used for DL communication to a fourth frequency used for UL communication; transmitting, via the third frequency, a fourth indication scheduling an additional UL communication from the second UE at an additional time that is no sooner than the additional minimum time after the fourth indication is expected to be decoded; and refraining from transmitting an additional DL communication via the third frequency within the additional minimum time before a starting time of the additional scheduled UL communication.

Aspect 21 is the method of any of aspects 11 to 17, 19, and 20, wherein the first indication indicates a first minimum time associated with switching from the first frequency used for DL communication to the second frequency used for UL communication and a second minimum time associated with switching from the second frequency used for UL communication to the first frequency used for DL communication, the method further comprising: refraining from transmitting the DL communication via the first frequency within the second minimum time after an end of the scheduled UL communication.

Aspect 22 is an apparatus for wireless communication at a device including a memory and at least one processor coupled to the memory and, based at least in part on information stored in the memory, the at least one processor is configured to implement any of aspects 1 to 10.

Aspect 23 is the apparatus of aspect 22, further including a transceiver or an antenna coupled to the at least one processor.

Aspect 24 is an apparatus for wireless communication at a device including means for implementing any of aspects 1 to 10.

Aspect 25 is a computer-readable medium (e.g., a non-transitory computer-readable medium) storing computer executable code, where the code when executed by a processor causes the processor to implement any of aspects 1 to 10.

Aspect 26 is an apparatus for wireless communication at a device including a memory and at least one processor coupled to the memory and, based at least in part on information stored in the memory, the at least one processor is configured to implement any of aspects 11 to 21.

Aspect 27 is the apparatus of aspect 26, further including a transceiver or an antenna coupled to the at least one processor.

Aspect 28 is an apparatus for wireless communication at a device including means for implementing any of aspects 11 to 21.

Aspect 29 is a computer-readable medium (e.g., a non-transitory computer-readable medium) storing computer executable code, where the code when executed by a processor causes the processor to implement any of aspects 11 to 21.

What is claimed is:

1. An apparatus for wireless communication at a user equipment (UE), comprising:
at least one memory; and
at least one processor coupled to the at least one memory and, based at least in part on stored information that is stored in the at least one memory, the at least one processor, individually or in any combination, is configured to:
transmit, to a network device, a first indication of a minimum time associated with switching between a first frequency used for downlink (DL) communication and a second frequency used for uplink (UL) communication;
receive, from the network device via the first frequency, a second indication scheduling an UL communication at a time that is no sooner than the minimum time after the second indication is received;
switch from the first frequency to the second frequency based on the second indication; and
transmit the scheduled UL communication via the second frequency.

2. The apparatus of claim 1, wherein the minimum time is indicated as a number of at least one of slots, symbols, or milliseconds.

3. The apparatus of claim 1, wherein the first indication is an index into an indexed set of candidate minimum times.

4. The apparatus of claim 1, wherein the first indication is a set of indexes comprising a first index associated with a first number of slots and a second index associated with a second number of symbols, wherein the minimum time is indicated to be the first number of slots plus the second number of symbols.

5. The apparatus of claim 1, wherein the first indication is of a UE category associated with the minimum time.

6. The apparatus of claim 1, wherein the first frequency and the second frequency are associated with a half-duplex (HD) frequency division duplexing (FDD) (HD-FDD) mode of operation.

7. The apparatus of claim 1, wherein the minimum time is based on a difference between the first frequency and the second frequency.

8. The apparatus of claim 1, wherein the UE does not expect DL communication during a first window preceding a beginning of the scheduled UL communication or during a second window following an end of the scheduled UL communication, wherein the first window and the second window span at least the minimum time.

9. The apparatus of claim 1, wherein a flexible slot is scheduled based on the minimum time.

10. The apparatus of claim 1, wherein the minimum time is a first minimum time associated with switching from the first frequency used for DL communication to the second frequency used for UL communication and a second minimum time associated with switching from the second frequency used for UL communication to the first frequency used for DL communication and the UE does not expect DL communication during a first window spanning at least the first minimum time preceding a beginning of the scheduled UL communication or during a second window spanning at least the second minimum time following an end of the scheduled UL communication.

11. A method of wireless communication at a user equipment (UE), comprising:
transmitting, to a network device, a first indication of a minimum time associated with switching between a first frequency used for downlink (DL) communication and a second frequency used for uplink (UL) communication;
receiving, from the network device via the first frequency, a second indication scheduling an UL communication at a time that is no sooner than the minimum time after the second indication is received;
switching from the first frequency to the second frequency based on the second indication; and
transmitting the scheduled UL communication via the second frequency.

12. The method of claim 11, wherein the minimum time is indicated as a number of at least one of slots, symbols, or milliseconds.

13. The method of claim 11, wherein the first indication is an index into an indexed set of candidate minimum times.

14. The method of claim 11, wherein the first indication is a set of indexes comprising a first index associated with a first number of slots and a second index associated with a second number of symbols, wherein the minimum time is indicated to be the first number of slots plus the second number of symbols.

15. The method of claim 11, wherein the first indication is of a UE category associated with the minimum time.

16. The method of claim 11, wherein the first frequency and the second frequency are associated with a half-duplex (HD) frequency division duplexing (FDD) (HD-FDD) mode of operation.

17. The method of claim 11, wherein the minimum time is based on a difference between the first frequency and the second frequency.

18. The method of claim 11, wherein the UE does not expect DL communication during a first window preceding a beginning of the scheduled UL communication or during a second window following an end of the scheduled UL communication, wherein the first window and the second window span at least the minimum time.

19. The method of claim 11, wherein a flexible slot is scheduled based on the minimum time.

20. A computer-readable medium storing computer executable code at a user equipment (UE), the computer executable code when executed by a processor causes the processor to:
transmit, to a network device, a first indication of a minimum time associated with switching between a first frequency used for downlink (DL) communication and a second frequency used for uplink (UL) communication;
receive, from the network device via the first frequency, a second indication scheduling an UL communication at a time that is no sooner than the minimum time after the second indication is received;
switch from the first frequency to the second frequency based on the second indication; and
transmit the scheduled UL communication via the second frequency.
